(19) United States
(12) Patent Application Publication
(10) Pub. No.: US 2014/0254321 A1
(43) Pub. Date: Sep. 11, 2014

(54) METHODS AND SYSTEMS FOR DETERMINING CLATHRATE PRESENCE AND SATURATION USING SIMULATED WELL LOGS

(71) Applicants: Timothy Scott Woelk, Houston, TX (US); Jeffrey William Nealon, Spring Valley, TX (US); Hugh Callahan Daigle, Houston, TX (US); Jacob Covault, The Woodlands, TX (US)

(72) Inventors: Timothy Scott Woelk, Houston, TX (US); Jeffrey William Nealon, Spring Valley, TX (US); Hugh Callahan Daigle, Houston, TX (US); Jacob Covault, The Woodlands, TX (US)

(73) Assignee: Chevron U.S.A. Inc., San Ramon, CA (US)

(21) Appl. No.: 13/790,659

(22) Filed: Mar. 8, 2013

(51) Int. Cl. G01V 1/30; G01V 1/28

(52) U.S. Cl. CPC G01V 1/306; G01V 1/282
USPC 367/73

(57) ABSTRACT

Methods and systems for determining a presence and saturation of clathrates are provided. One method includes identifying a potential zone of clathrates based on observed seismic data, the observed seismic data including an observed signal amplitude at the potential zone of clathrates, and assigning subsurface sediment types within and around the potential zone of clathrates. The method includes creating one or more lithologic type logs based on the interpreted subsurface sediment types, and creating from each of the one or more lithologic type logs a plurality of synthetic logs including compressional velocity at a plurality of possible clathrate saturation levels. The method includes matching expected signals from one of the plurality of synthetic logs to the observed signals in the observed seismic data to determine a best-fit match synthetic log to the observed seismic data, thereby determining a clathrate saturation level from among the plurality of possible clathrate saturation levels.

### TECHNICAL FIELD

The present application relates generally to analysis of well logs, including simulated well logs, to determine the presence of subsurface clathrates.

### BACKGROUND

“Clathrates” generally refer to non-stoichiometric metastable substances in which lattice structures composed of first molecular components (host molecules) trap or encage one or more other molecular components (guest molecules) in what resembles a crystal-like structure. Clathrates are sometimes referred to as inclusion compounds, hydrates, gas hydrates, methane hydrates, natural gas hydrates, C02 hydrates and the like.

In the field of hydrocarbon exploration and development, clathrates are of particular interest. For example, clathrates exist in which water host molecule lattices encage one or more types of hydrocarbon guest molecule(s). Such hydrocarbon clathrates occur naturally in environments of relatively low temperature and high pressure where water and hydrocarbon molecules are present, such as in deepwater and permafrost sediments. Clathrates at lower temperatures remain stable at lower pressures, and conversely clathrates at higher temperatures require higher pressures to remain stable.

Traditionally, seismic interpretation based on seismic data is used to identify potential zones where clathrates, such as methane hydrates, accumulate as a drilling hazard. This is typically done in a qualitative sense, by determining areas of high amplitude and/or high impedance in seismic data received from well logs, for example to detect areas having greater material density. This arrangement is acceptable for detecting clathrates as a drilling hazard, because existence and location, rather than density, is of primary concern in that context.

However, in other contexts, mere location of clathrates is insufficient. For example, existing analyses of seismic data from existing well logs do not address the volume of hydrate in place for its potential as a resource. Absent some sense for a volume or saturation of clathrates, it may be difficult to determine if harvesting efforts for such clathrates may prove cost-effective.

As such, improvements in the area of seismic interpretation of well logs to detect clathrates are desirable.

### SUMMARY

In accordance with the following disclosure, the above and other issues are addressed by the following:

In a first aspect, a method of determining a presence and saturation of clathrates includes identifying a potential zone of clathrates based on observed seismic data, the observed seismic data including an observed signal amplitude at the potential zone of clathrates, and assigning subsurface sediment types within and around the potential zone of clathrates. The method also includes creating one or more lithologic type logs based on the interpreted subsurface sediment types, and creating from each of the one or more lithologic type logs a plurality of synthetic logs including compressional velocity at a plurality of possible clathrate saturation levels. The method further includes matching expected signals from one of the plurality of synthetic logs to the observed signals in the observed seismic data to determine a best-fit match synthetic log to the observed seismic data, thereby determining a likely clathrate saturation level from among the plurality of possible clathrate saturation levels.

In a second aspect, a computer-readable storage medium comprising computer-executable instructions is disclosed which, when executed, cause a computing system to perform a method of determining a presence and saturation of clathrates. The method includes identifying a potential zone of clathrates based on observed seismic data, the observed seismic data including an observed signal amplitude at the potential zone of clathrates, and assigning subsurface sediment types within and around the potential zone of clathrates. The method also includes creating one or more lithologic type logs based on the interpreted subsurface sediment types, and creating from each of the one or more lithologic type logs a plurality of synthetic logs including compressional velocity at a plurality of possible clathrate saturation levels. The method further includes matching expected signals from one of the plurality of synthetic logs to the observed signals in the observed seismic data to determine a best-fit match synthetic log to the observed seismic data, thereby determining a likely clathrate saturation level from among the plurality of possible clathrate saturation levels.

In a third aspect, a system includes a computing system including a programmable circuit and a memory, and computer-executable instructions stored in the memory. The computer-executable instructions are arranged to form a clathrate presence and saturation application program including a seismic data observation component configured to allow location of a potential zone of clathrates based on observed seismic data, the observed seismic data including an observed signal amplitude at the potential zone of clathrates. The program also includes a stratigraphic interpretation component used to assign subsurface sediment types within and around the potential zone of clathrates, and a lithologic type log component configured to generate one or more lithologic type logs based on the interpreted subsurface sediment types. The program further includes a synthetic log generator configured to generate a plurality of synthetic logs including compressional velocity at a plurality of possible clathrate saturation levels from each of the one or more lithologic type logs, and a signal matching component configured to determine a best-fit match synthetic log to the observed seismic data, thereby determining a likely clathrate saturation level from among the plurality of possible clathrate saturation levels.

### BRIEF DESCRIPTION OF THE DRAWINGS

FIG. 1 is a schematic illustration of an offshore hydrocarbon production system including a production facility which receives and processes hydrocarbons from one or more clathrate reservoirs;

FIG. 2 is a schematic illustration of an onshore hydrocarbon production system including a production facility which receives and processes hydrocarbons from one or more clathrate reservoirs;

FIG. 3 is a schematic illustration of a computing system in which seismic data can be analyzed to determine presence and saturation of clathrates;

FIG. 4 is a flowchart illustrating a method for determining a presence and saturation of clathrates, in an example embodiment;

FIG. 5 is an annotated seismic data graph illustrating a zone of potential clathrate formation;

FIG. 6 is an example portion of the seismic data graph of FIG. 5 having stratigraphic information identified thereon;

FIG. 7 is an example velocity pull-up map illustrating areas where velocity pull-up occurs in seismic data;

FIG. 8 is an example graph illustrating compressional velocity relative to depth at a particular subsurface location representing a synthetic well log;

FIG. 9 is an example graph illustrating comparison between observed and expected signals based on reflectivity matching to determine a presence and saturation of clathrates at a particular subsurface location;

FIG. 10 is an example graph illustrating comparison between observed and expected signals based on velocity pull-up matching to determine a presence and saturation of clathrates at a particular subsurface location; and

FIG. 11 is an example portion of the seismic data graph of FIG. 5 having estimated clathrate presence and saturation identified.

### DETAILED DESCRIPTION

As briefly described above, embodiments of the present invention are directed to methods and systems for detecting the presence and saturation of clathrates, such as methane hydrates, in a underground, or subsurface, location. In particular, the methods and systems discussed herein provide for differentiation of hydrates from other high reflectivity events, and also quantify the amount of the clathrate that is at the specific location.

It is noted that, in general, the possible zones of clathrates generally will be represented in seismic data as shallow, high reflectivity zones that appear in seismic data, but which do not have the same characteristics, relating to velocity pull-up and reflectivity matching, as other possible anomalies in the seismic data, such as free gas. The methods and systems discussed herein provide for differentiation of hydrates from other high reflectivity events, and also quantify the amount of the clathrate that is at the specific location. This differentiation can help high grade portfolios and identify potential drilling hazards. The identification and quantification of methane hydrate in place allows for identification of commercially-viable saturations of accumulated clathrates, for example for drilling and production.

For the purposes of this disclosure, the term “clathrate” will include any and all types of lattice (host) molecule(s) and any and all types of encaged (guest) molecule(s) in all possible combinations. Clathrates can include, for example, transitions between various clathrate lattice structure types; formation, stable state and dissociation, and the substitution of one or more type(s) of molecule by one or more other type(s) of molecule.

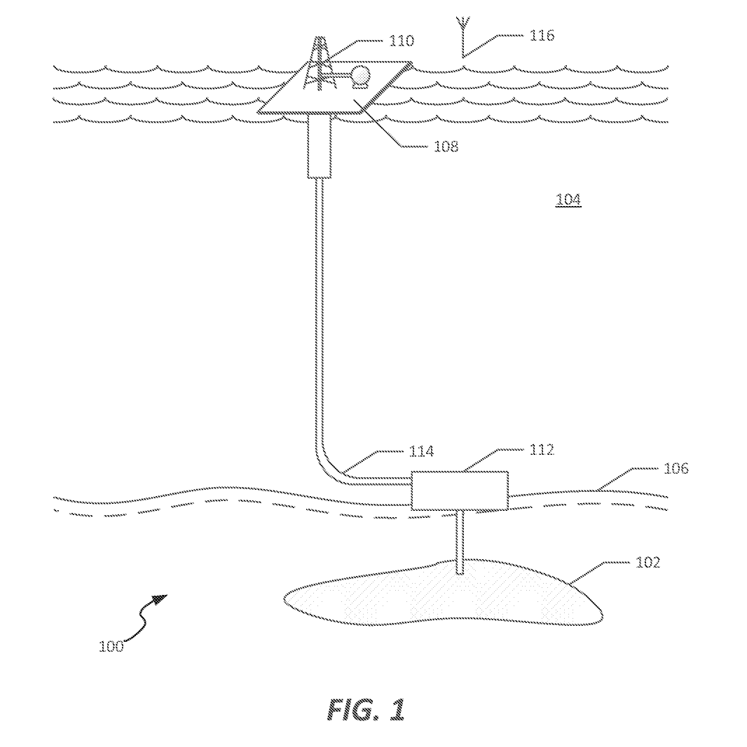

FIG. 1 is a schematic drawing of an example embodiment of an offshore or deepwater hydrocarbon production system 100. System 100 includes a clathrate reservoir 102 disposed beneath sea water 104 and seafloor 106. This clathrate reservoir 102 produces water and hydrocarbons, primarily natural gas. In the embodiment shown, an offshore platform 108 supports a production facility 110, which is used to at least partially separate liquids, water and/or oil, from natural gas.

In this example embodiment, the clathrate reservoir 102 is shown in fluid communication with a subsea well 112 which, in turn, is connected to production facility 110 by way of tieback 114. Clathrate reservoir 102 primarily produces a mixture of natural gas and water which is delivered to production facility 110 for separation of natural gas and water, and oil if there are significant amounts of oil contained within the mixture.

It is noted that, in the embodiment shown in FIG. 1, a wave generation and detection system 116 can be used prior to installation of the overall hydrocarbon production system 100, and can be used to locate the system 100 at a particular location along the seafloor 106. The wave generation and detection system 116 can be, for example a seismic or other acoustic wave generation system, or other system capable of generating waves that are able to penetrate the sea water 104 and seafloor 106, and to capture reflected waves, and thereby detect differences in the media through which the waves travel based on speed of travel.

It is noted that the production system 100 shown in FIG. 1 is only an exemplary embodiment. Those skilled in the art will appreciate that it is within the scope of the present invention to provide a hydrocarbon production system that combines multiple such clathrate reservoirs and associated wells, or combination of such a clathrate reservoir and associated well with conventional hydrocarbon reservoir and well systems. An example of such a system is illustrated in U.S. Pat. No. 8,232,428, filed Aug. 25, 2008, the disclosure of which is hereby incorporated by reference in its entirety.

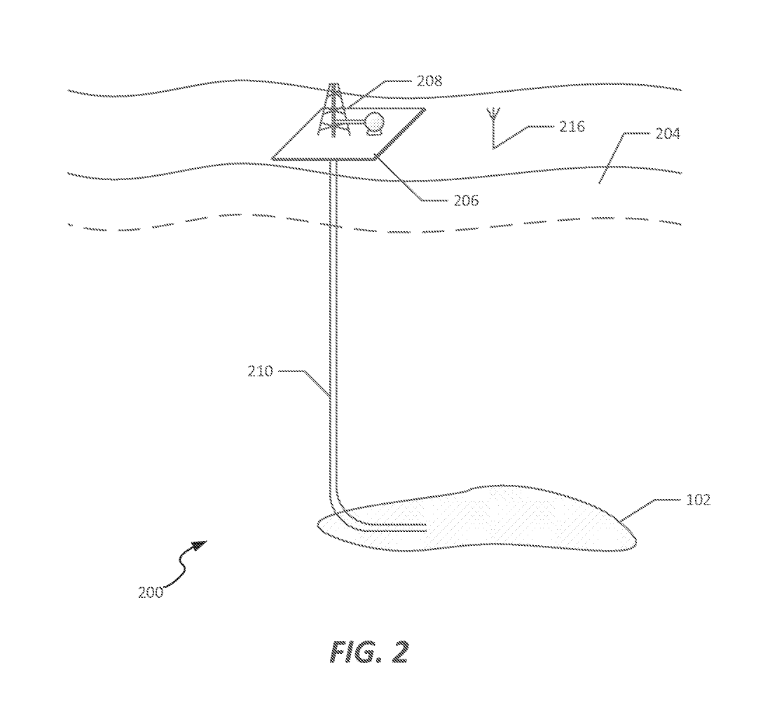

FIG. 2 is a schematic drawing of another exemplary embodiment of a hydrocarbon production system 200 which, in this case, is located on land rather than being based offshore. Production system 200 includes a clathrate reservoir 202. Disposed upon a permafrost layer 204 is an arctic platform 206. A production facility 208, generally similar to production system 110, is located atop arctic platform 206. Production facility 208 is used to separate and process natural gas, oil and water received from the clathrate reservoir 202. Production tubing 210 is used to fluidly convey a mixture of clathrates and water from clathrate reservoir 202 to arctic platform 206 and production facility 208. The mixture may include, in some cases, a small portion of oil.

As with the hydrocarbon production system 100 of FIG. 1, it is noted that in the context of the on-land arrangement of FIG. 2, a wave generation and detection system 216, analogous to system 116 of FIG. 1, can be used prior to installation of the overall hydrocarbon production system 200, and can be used to locate the system 200 at a particular location. The wave generation and detection system 216 can include any of a variety of types of seismic, acoustic, or other system capable of generating waves that are able to penetrate the permafrost layer 204, and to capture reflected waves, and thereby detect differences in the media through which the waves travel based on speed of travel. It is noted that, in the example of FIG. 2, there are likely to be greater variations in densities at shallower depths, based on the comparative uniformity of sea water as compared to variations found in the on-land subsurface sediments. In either case, such data can be captured for use in some embodiments of the present disclosure, as discussed in further depth below.

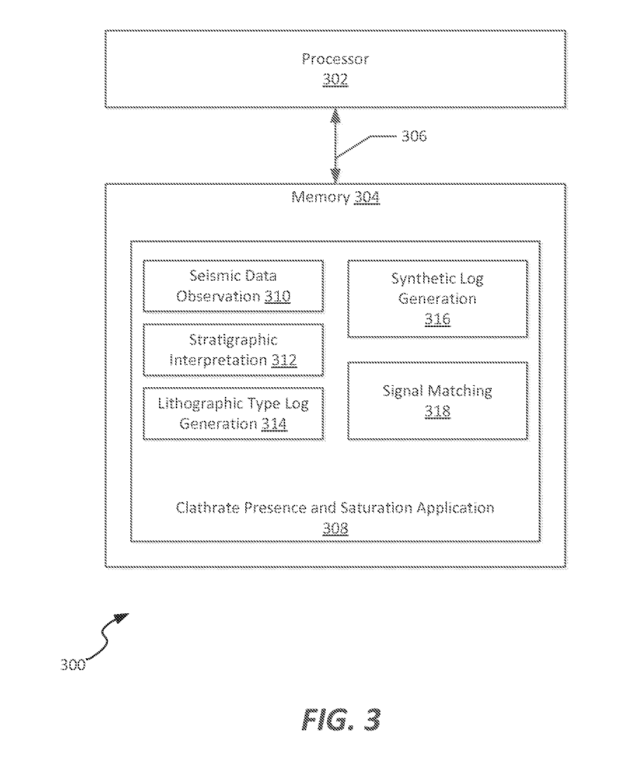

Referring now to FIG. 3, an example computing system 300 is illustrated that can be used to determining an expected presence and saturation of clathrates, such as can be used to locate a production system such as those shown in FIGS. 1-2. In general, the computing system 300 includes a processor 302 communicatively connected to a memory 304 via a data bus 306. The processor 302 can be any of a variety of types of programmable circuits capable of executing computer-readable instructions to perform various tasks, such as mathematical and communication tasks.

The memory 304 can include any of a variety of memory devices, such as using various types of computer-readable or computer storage media. A computer storage medium or computer-readable medium may be any medium that can contain or store the program for use by or in connection with the instruction execution system, apparatus, or device. In the embodiment shown, the memory 304 stores a clathrate presence and saturation determination application 308. The application 308 includes a plurality of components, including a seismic data observation component 310, a stratigraphic interpretation component 312, a lithologic type log generation component 314, a synthetic log generation component 316, and a signal matching component 318.

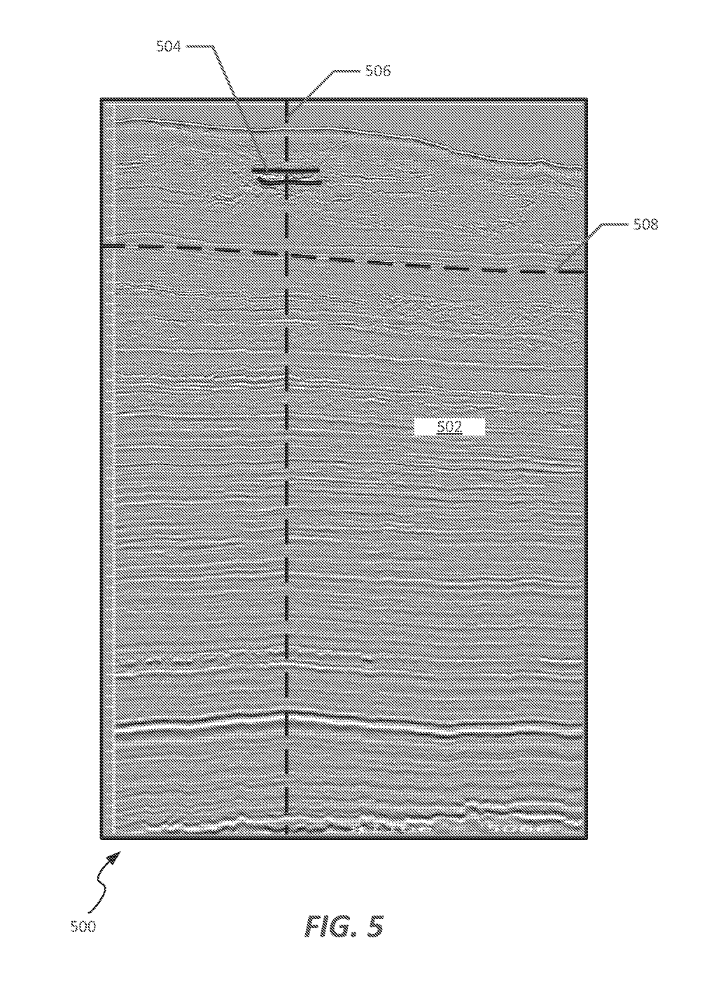

The seismic data observation component 310 receives seismic data provided to the computing system 300, for example as may be received from a wave generation and detection system 116, 216 of FIGS. 1-2, above. The seismic data observation component 310 can be configured, in some embodiments, to present a display of the seismic data and allow a user to view and identify one or more areas to further analyze for potential presence of clathrates (e.g., methane hydrates). For example, an interactive display can present two-dimensional or three-dimensional seismic data to the user, and allow the user to (with or without assistance by the computing system) locate one or more areas where seismic signals experience a high velocity, high impedance event. Such cases generally exhibit a large velocity pull-up, i.e., where the signal appears shallower than in surrounding areas based on faster traversal of the area having greater density. The interactive display can also allow the user to select such areas, and to define a clathrate stability zone, i.e., a location where pressure and temperature are sufficiently high to support clathrate formation. An example of such a display is provided in FIG. 5, below.

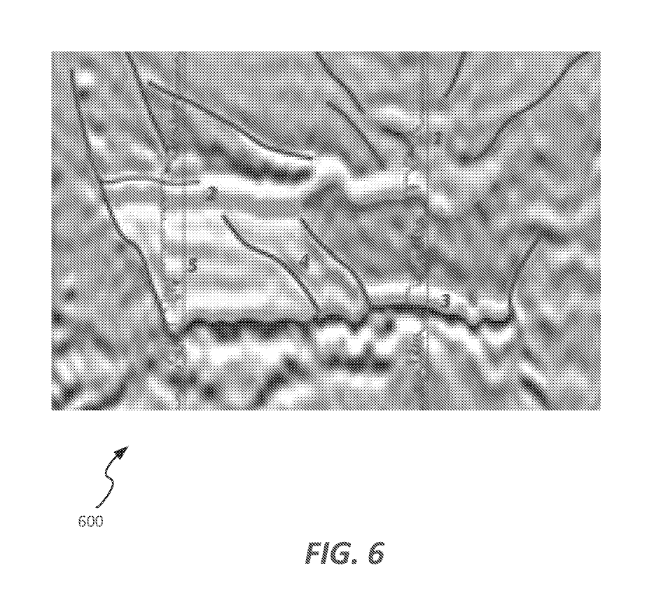

The stratigraphic interpretation component 312 can be used, after identification of possible zones of clathrate formation, to identify different zones of likely sediment types. For example, in example embodiments, a user can use the stratigraphic interpretation component 312 to trace boundaries between types of sediments, and to assign sediment types to the various subsurface features observed. For example, in some cases, a user may assign a particular region to represent a sand pocket in the subsurface sediment, and a second region to represent shale. In such cases, it is noted that clathrates may form in the sand areas, but will not form within the shale areas. An example of such stratographic interpretation is illustrated in FIG. 6, discussed in further detail below. The lithologic type log generation component 314 generates at least one lithologic type log. Lithologic type logs generally correspond to logs of the various identified types of stone materials, as defined in the stratigraphic interpretation component 312.

The synthetic log generation component 316 generates one or more types of “synthetic” logs based on the lithologic type log. The synthetic logs can take a variety of forms. In one possible embodiment, the synthetic logs created using the synthetic log generation component 316 can be compressional velocity logs that can be used to match observed compressional velocities in observed locations where clathrate deposits may exist. In alternative embodiments, the synthetic log generation component 316 can generate a set of logs representing a synthetic well log, including one or more of compressional velocity logs, shear velocity logs, density logs, and porosity logs. In either case, the generated logs are generated such that more than one such log is generated for each of the lithologic type logs. Specifically, a plurality of such logs is created at a variety of different possible clathrate concentrations between 0% and 100%. In some cases, a set of possible concentrations, at 10% intervals are created. In other cases, 20% concentration intervals can be used. Other arrangements are possible as well.

The signal matching component 318 is used to match aspects of a synthetic log to the observed seismic data. This can be done in a variety of ways. In some embodiments, a signal amplitude in an area where the clathrate deposit is suspected is compared between the synthetic log and an associated area in the observed log to determine a best-fit match between one of the logs at a particular concentration and signals in the seismic data in the area of suspected clathrates. For example, a signal amplitude in a compressional velocity log generated from a lithologic type log having a particular concentration (e.g., 60%) is compared to a compressional velocity observed in the seismic data to determine that the signal amplitude in the suspected zone of clathrate concentration has a best fit, for example as compared to a signal amplitude computed for a compressional velocity log representing a 40%, 50%, 70%, or other clathrate concentration.

In alternative embodiments, the signal matching component 318 can use other types of signal attributes to perform this best-fit match, or can use other types of synthetic logs that are comparable to the actual seismic data. For example, both signal amplitude and frequency in and surrounding the suspected zone of clathrate concentration can be matched to locate a best fit concentration when comparing synthetic and actual data. Furthermore, beyond performing this comparison using compressional velocity, other types of generated logs (e.g., shear velocity logs, density logs, and porosity logs) or more than one type of log, could be used to perform this matching process.

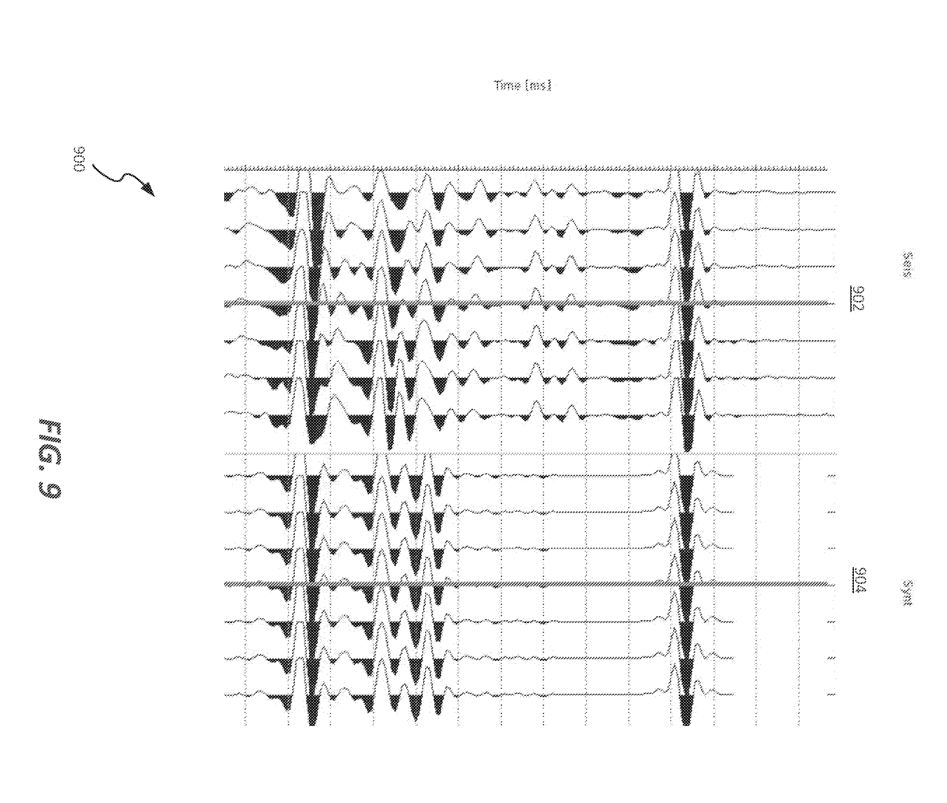

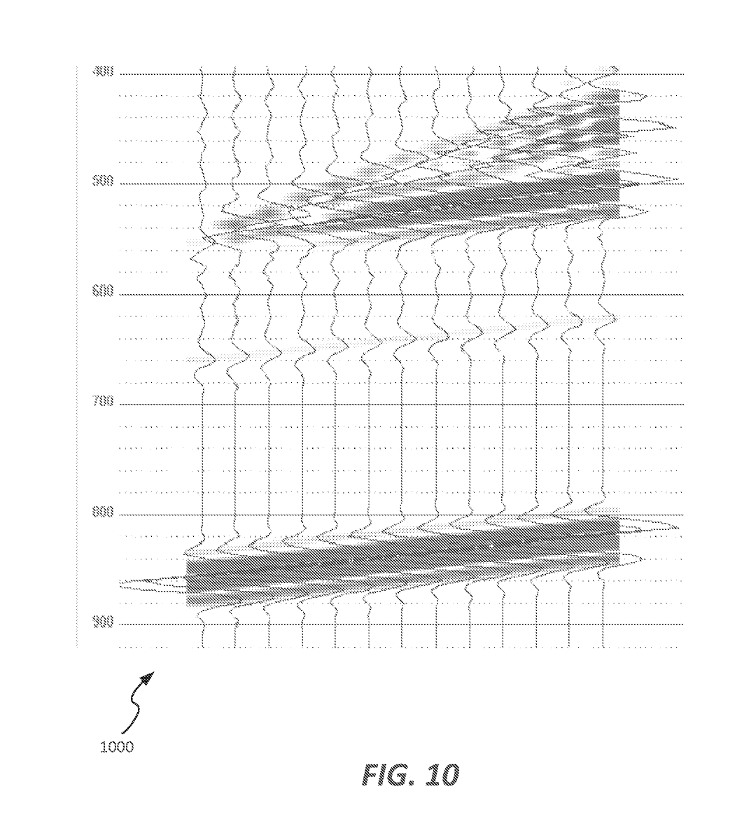

It is noted that the best-fit matching can be performed in a variety of ways. In a first embodiment, a velocity pull-up effect is matched between the seismic data and the synthetic logs, representing an amount of pull-up that is observed with a computed pull up occurring in the synthetic logs, in particular in the compressional velocity logs. In a second, alternative embodiment, a reflectivity matching process is performed, comparing reflectivity in the seismic data to reflectivity in observed seismic data. Examples of these matching processes are illustrated in FIGS. 9 and 10, discussed in further detail below.

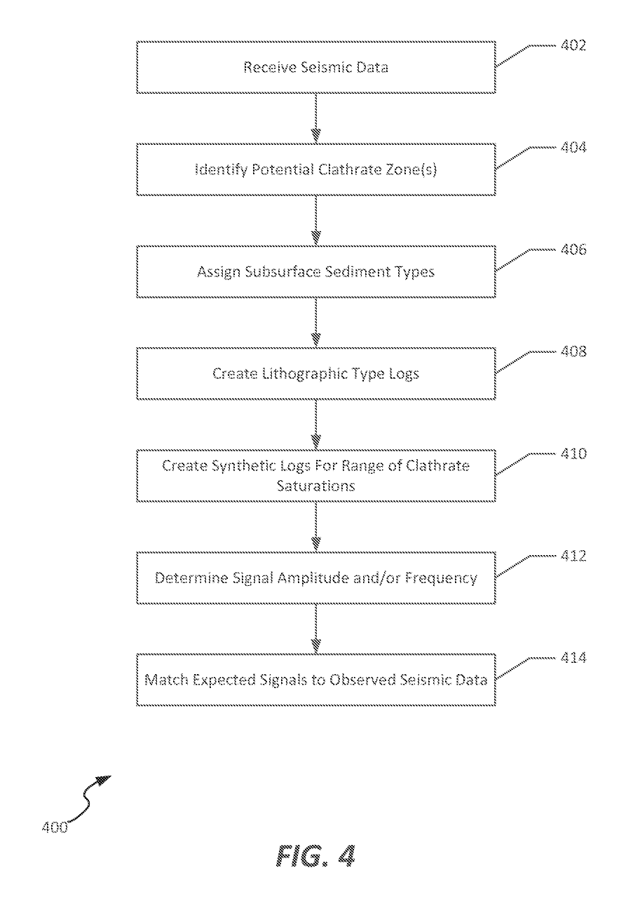

Referring now to FIG. 4, a method 400 for determining a presence and saturation of clathrates is illustrated, in an example embodiment of the present disclosure. In the embodiment shown, the method 400 includes receiving seismic data, for example from an area in which clathrate exploration is performed (step 402). This can include, for example, capture of seismic data using a wave generation and detection system 116, 216 of FIGS. 1-2. The method also includes identifying a potential zone of clathrates, such as methane hydrates, in observed seismic data (step 404). The observed seismic data can include data that has an observed signal amplitude and frequency at a variety of depths and locations, including within and surrounding the potential zone of clathrates. The potential zone of clathrates can be located, for example at a depth where pressure and temperature are sufficiently high to support clathrate formation, and where anomalous seismic features are observed due to changes in a velocity pull-up or reflectivity of the seismic signal.

The method 400 further includes assigning one or more subsurface sediment types within and around the potential zone of clathrates, such as by identifying regions of sand and shale in and around the suspected area, as identified by a user (step 406). A lithologic log can then be created based on the identified subsurface sediment types (step 408).

From the lithologic log created, a plurality of synthetic logs are then created (step 410). As noted above, a variety of types of different synthetic logs can be created at each of a plurality of possible clathrate concentrations, from 0% to 100%. The synthetic logs can include a compressional velocity logs, shear velocity logs, density logs, or porosity logs, as noted above. Once the synthetic logs are created, frequency and amplitudes of features in the synthetic logs can be calculated (step 412), for example in an area near and surrounding the previously-identified possible zone of clathrates. This can include, for example, calculating an amplitude of a velocity pull-up, or calculating an amplitude and frequency of a signal for purposes of reflectivity matching. Based on the calculated amplitude and/or frequency, these “expected” signals are compared to the observed seismic data to determine a best-fit match synthetic log to the observed seismic data (step 414). Once a best-fit match is found, that specific synthetic log is associated with a particular clathrate concentration, which corresponds to an estimated clathrate concentration from among the various possible clathrate concentrations represented by the different synthetic logs.

Referring now to FIGS. 5-11, example graphs that can be generated using the systems and methods of the present disclosure are illustrated. FIG. 5 illustrates an annotated seismic data graph 500 illustrating a zone of potential clathrate formation. The graph 500 includes seismic data 502 for a particular area. In the embodiment shown, the seismic data 502 includes a seismic anomaly 504, shown as outlined by short lines. The seismic anomaly can be selected using a graphical interface displayed by a computing system having a clathrate presence and saturation determination application 308 executing thereon.

In the embodiment shown, the user can select the anomaly 504, and can identify a simulated well location 506 along which a synthetic seismic log can be generated, using the systems and methods discussed above. Additionally, the user can define a line 508 denoting an edge of a clathrate stability zone, corresponding to a depth and location where clathrates, and in particular methane hydrates, can be located.

As illustrated in FIG. 6, a portion 600 of the seismic data graph 500 is shown with stratigraphic information labeled thereon, including areas of sand and shale. In the embodiment shown, five separate areas are identified (labeled 1-5). These areas correspond to varying areas of sand and shale, and are selected and labeled based on user experience with such stratigraphic formations.

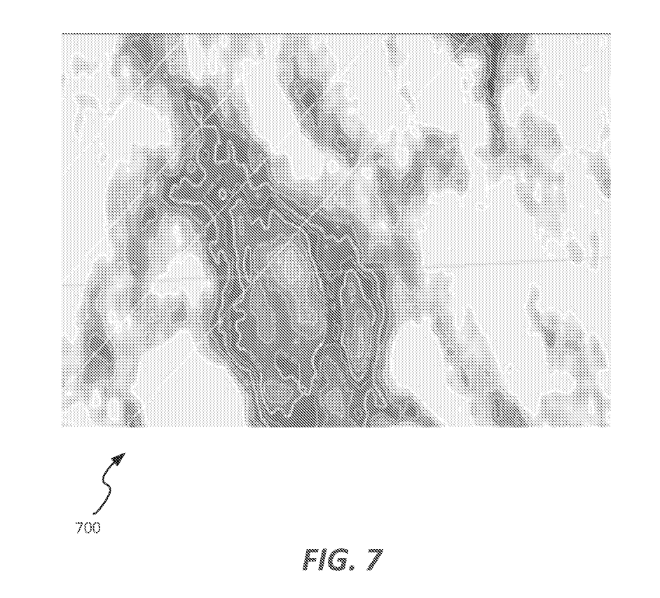

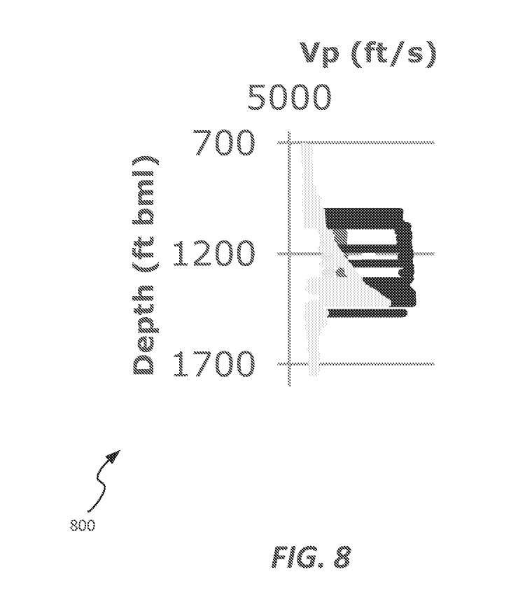

FIG. 7 is an example velocity pull-up map 700 illustrating areas where velocity pull-up occurs in seismic data. The velocity pull-up map can be generated in the general location where the possible zone of clathrate formation, represented by the seismic anomaly 504, is shown. The velocity pull-up map illustrates relative velocity pull-up regions, which may be due to either clathrate formation or the existence of shale or some other high-density feature. Based on the velocity pull-up, and based on the areas in which sand is present, it can be assumed that some possible level of clathrates may be present. As illustrated in FIG. 8, an example graph 800 illustrating compressional velocity relative to depth at a particular subsurface location representing a synthetic well log is shown. The graph 800 can be, for example, at a site of a possible zone of clathrates. As illustrated in the graph 800, a compressional velocity is mapped across a variety of depths of interest, in and around a zone of possible clathrate formation. In the example shown, an area from about 1000 to about 1500 feet below a marine subsurface level is illustrated as having a high compressional velocity. Based on the graph 800, a signal amplitude can be detected.

Referring now to FIGS. 9-10, graphs illustrating a matching process, representing a reflectivity matching and a velocity pull-up matching arrangements, respectively, are shown. FIG. 9 is an example graph 900 illustrating comparison between observed and expected signals based on reflectivity matching to determine a presence and saturation of clathrates at a particular subsurface location. The graph 900 illustrates a process by which an existing seismic data, referred to as data 902, is matched to a particular portion of synthetic data, referred to as data 904. In particular, an amplitude and frequency of anomalous events in each set of data are compared, and a particular set of synthetic data 904 is selected that best matches the seismic data 902 to determine a clathrate saturation in a particular area.

Analogously, in FIG. 10, an example graph 1000 is shown, illustrating comparison between observed and expected signals based on velocity pull-up matching to determine a presence and saturation of clathrates at a particular subsurface location. The graph 1000 illustrates various levels of velocity pull-up. At a leftmost section of the graph, little if any pull-up is exhibited, indicating little velocity pull-up. At a rightmost section of the graph, velocity pull-up is illustrated. Various velocity pull-up amounts will generally have different slopes. By matching a slope of velocity pull-up in synthetic data to the velocity pull-up observed in the seismic data, various concentrations of clathrates can be detected.

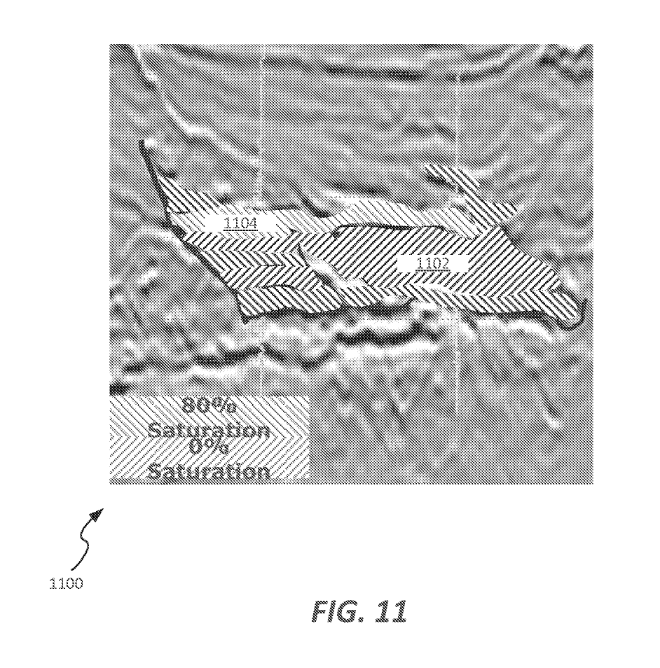

Referring to FIG. 11, an example portion 1100 of the seismic data graph 500 of FIG. 5 having estimated clathrate presence and saturation identified. In the portion 1100 shown, various concentrations of clathrates are illustrated. In the embodiment shown, the portion 1100 includes an 80% concentration level 1102 and a 0% concentration level 1104, mapped to various regions within the zone of possible clathrate concentration.

Referring to FIGS. 1-11 overall, it is noted that, once clathrate saturations are determined, it can be substantially easier and more effective to prioritize different areas of clathrate deposits for harvesting. Furthermore, and referring to in particular computing systems embodying the methods and systems of FIGS. 3-4, it is noted that various computing systems can be used to perform the processes disclosed herein. For example, embodiments of the disclosure may be practiced in various types of electrical circuits comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, aspects of the methods described herein can be practiced within a general purpose computer or in any other circuits or systems.

Embodiments of the present disclosure can be implemented as a computer process (method), a computing system, or as an article of manufacture, such as a computer program product or computer readable media. The computer program product may be a computer storage media readable by a computer system and encoding a computer program of instructions for executing a computer process. Accordingly, embodiments of the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media. Further, the disclosed methods' stages may be modified in any manner, including by reordering stages and/or inserting or deleting stages, without departing from the overall concept of the present disclosure.

The above specification, examples and data provide a complete description of the manufacture and use of the composition of the invention. Since many embodiments of the invention can be made without departing from the spirit and scope of the invention, the invention resides in the claims hereinafter appended.

1. A method of determining a presence and saturation of clathrates, the method comprising:
identifying a potential zone of clathrates based on observed seismic data, the observed seismic data including an observed signal amplitude at the potential zone of clathrates;
assigning subsurface sediment types within and around the potential zone of clathrates;
creating one or more lithologic type logs based on the interpreted subsurface sediment types;
creating from each of the one or more lithologic type logs a plurality of synthetic logs including compressional velocity at a plurality of possible clathrate saturation levels; and
matching expected signals from one of the plurality of synthetic logs to the observed signals in the observed seismic data to determine a best-fit match synthetic log to the observed seismic data, thereby determining a likely clathrate saturation level from among the plurality of possible clathrate saturation levels.

2. The method of claim 1, wherein the plurality of synthetic logs includes compressional velocity logs.

3. The method of claim 1, wherein the plurality of synthetic logs includes compressional velocity logs, shear velocity logs, density logs, and porosity logs.

4. The method of claim 3, further comprising creating synthetic seismic models from the velocity logs, shear velocity logs, density logs, and porosity logs.

5. The method of claim 4, wherein creating the synthetic seismic models includes calculating an expected signal amplitude and frequency, wherein the expected signal amplitude and frequency comprise the expected signals.

6. The method of claim 5, wherein matching expected signals from one of the plurality of synthetic logs to the observed signals in the observed seismic data includes matching the expected signal amplitude and frequency to the observed signals.

7. The method of claim 1, wherein interpreting subsurface sediment types within and around the potential zone of clathrates includes identifying areas of sand and shale within and around the potential zone of clathrates.

8. The method of claim 1, wherein the range of clathrate saturations range from 0% to 100% clathrate saturation.

9. The method of claim 1, wherein the clathrates include methane hydrates.

10. The method of claim 1, wherein identifying a potential zone of clathrates based on observed seismic data includes locating an anomalous zone in observed seismic data.

11. The method of claim 10, wherein identifying a potential zone of clathrates based on observed seismic data includes determining that the potential zone is above a hydrate stability zone.

12. The method of claim 1, wherein matching expected signals from one of the plurality of synthetic logs to the observed signals in the observed seismic data includes performing a reflectivity matching process.

13. A computer-readable storage medium comprising computer-executable instructions which, when executed, cause a computing system to perform a method of determining a presence and saturation of clathrates, the method comprising:
identifying a potential zone of clathrates based on observed seismic data, the observed seismic data including an observed signal amplitude at the potential zone of clathrates;
assigning subsurface sediment types within and around the potential zone of clathrates;
creating one or more lithologic type logs based on the interpreted subsurface sediment types;
creating from each of the one or more lithologic type logs a plurality of synthetic logs including compressional velocity at a plurality of possible clathrate saturation levels; and
matching expected signals from one of the plurality of synthetic logs to the observed signals in the observed seismic data to determine a best-fit match synthetic log to the observed seismic data, thereby determining a likely clathrate saturation level from among the plurality of possible clathrate saturation levels.

14. The computer-readable storage medium of claim 13, wherein the plurality of synthetic logs includes compressional velocity logs.

15. The computer-readable storage medium of claim 13, wherein the plurality of synthetic logs includes compressional velocity logs, shear velocity logs, density logs, and porosity logs.

16. The computer-readable storage medium of claim 15, further comprising creating synthetic seismic models from the velocity logs, shear velocity logs, density logs, and porosity logs.

17. The computer-readable storage medium of claim 16, wherein creating the synthetic seismic models includes calculating an expected signal amplitude and frequency, wherein the expected signal amplitude and frequency comprise the expected signals.

18. The computer-readable storage medium of claim 16, wherein the lithologic type logs comprise gamma ray type logs.

19. The computer-readable storage medium of claim 13, further comprising calculating an expected signal amplitude in each of the plurality of synthetic logs.

20. A system comprising:
a computing system including a programmable circuit and a memory;
computer-executable instructions stored in the memory and arranged to form a clathrate presence and saturation application program including:
a seismic data observation component configured to allow location of a potential zone of clathrates based on observed seismic data, the observed seismic data including an observed signal amplitude at the potential zone of clathrates;
a stratigraphic interpretation component used to assign subsurface sediment types within and around the potential zone of clathrates;
a lithologic type log component configured to generate one or more lithologic type logs based on the interpreted subsurface sediment types;
a synthetic log generator configured to generate a plurality of synthetic logs including compressional velocity at a plurality of possible clathrate saturation levels from each of the one or more lithologic type logs; and
a signal matching component configured to determine a best-fit match synthetic log to the observed seismic data, thereby determining a likely clathrate saturation level from among the plurality of possible clathrate saturation levels.
